(19) United States
(12) Patent Application Publication
(10) Pub. No.: US 2017/0313306 A1
(43) Pub. Date: Nov. 2, 2017

(54) METHOD AND DEVICE FOR THE ASSISTED DRIVING OF A VEHICLE

(71) Applicant: Robert Bosch GmbH, Stuttgart (DE)

(72) Inventor: Stefan Nordbruch, Kornwestheim (DE)

(73) Assignee: Robert Bosch GmbH, Stuttgart (DE)

(21) Appl. No.: 15/523,116

(22) PCT Filed: Oct. 22, 2015
(86) PCT No.: PCT/EP2015/074489

§ 371 Date: Apr. 28, 2017

(30) Foreign Application Priority Data
Nov. 26, 2014 (DE) 10 2014 224 077.8

(51) Int. Cl. B60W 30/06; G01C 21/36; G05D 1/00; G05D 1/02; G08G 1/14; H04W 84/00; H04L 29/08

(52) U.S. Cl. CPC B60W 30/06; G05D 1/0225; G01C 21/3685; G05D 1/0011; G08G 1/148; G05D 1/0285; G05D 1/0088; B60W 2550/402; H04L 67/12; H04W 84/005

(57) ABSTRACT

A method for the assisted driving of a vehicle. A setpoint trajectory for the vehicle to be followed in a parking facility being ascertained as a function of a type of the vehicle. The ascertained setpoint trajectory is transmitted to the vehicle via a communication network. A digital map of the parking facility is transmitted to the vehicle via the communication network. The vehicle may autonomously drive in the parking facility based on the setpoint trajectory and the digital map. Additionally, the vehicle may be monitored with the aid of a vehicle-external monitoring system while it is driving autonomously in the parking facility. A device for the assisted driving of a vehicle, a method and a device for operating a vehicle, a parking system for vehicles, a vehicle, and a computer program, are also described.

### FIELD

The present invention relates to a method and to a device for the assisted driving of a vehicle. The present invention furthermore relates to a method and to a device for operating a vehicle. The present invention furthermore relates to a parking system for vehicles, to a vehicle, and to a computer program.

### BACKGROUND INFORMATION

German Patent Application No. DE 10 2012 222 562 A1 describes a system for managed parking areas for transferring a vehicle from a start position into a target position.

In the case of fully automated (autonomous) so-called valet parking, a driver parks a vehicle in a drop-off spot, for example in front of a parking garage, and from there the vehicle drives itself into a parking position/parking space and back to the drop-off spot.

### SUMMARY

It is an object of the present invention to provide efficient autonomously driving of a vehicle in a parking facility.

Advantageous example embodiments of the present invention are described herein.

According to one aspect, a method for the assisted driving of a vehicle is provided,
a setpoint trajectory for the vehicle to be followed in a parking facility being ascertained as a function of a type of the vehicle;
the ascertained setpoint trajectory being transmitted to the vehicle via a communication network;
a digital map of the parking facility being transmitted to the vehicle via the communication network,
so that the vehicle is able to autonomously drive in the parking facility based on the setpoint trajectory and the digital map; and
the vehicle being monitored with the aid of a vehicle-external monitoring system while it is driving autonomously in the parking facility.

According to one further aspect, a device for the assisted driving of a vehicle is provided, including:
a processor which is designed to ascertain a setpoint trajectory for the vehicle to be followed in a parking facility as a function of a type of the vehicle;
a communication interface which is designed to transmit the ascertained setpoint trajectory and a digital map of the parking facility to the vehicle via a communication network, so that the vehicle is able to autonomously drive in the parking facility based on the setpoint trajectory and the digital map; and
a control unit for controlling a vehicle-external monitoring system in such a way that the vehicle is being monitored with the aid of the vehicle-external monitoring system while it is driving autonomously in the parking facility.

According to yet another aspect, a method for operating a vehicle is provided,
the vehicle receiving via a communication network a setpoint trajectory, which is to be followed in the parking facility and is dependent on a type of the vehicle, and a digital map of the parking facility,
the vehicle autonomously driving in the parking facility based on the setpoint trajectory and the digital map.

According to yet another aspect, a device for operating a vehicle is provided, including:
a communication interface which is designed to receive via a communication network a setpoint trajectory, which is to be followed in the parking facility and is dependent on a type of the vehicle, and a digital map of the parking facility; and
a guide device for guiding the vehicle, which is designed to autonomously guide the vehicle in the parking facility based on the setpoint trajectory and the digital map.

According to yet another aspect, a parking system for vehicles is provided, the parking system including a parking facility and the device for the assisted driving of a vehicle.

According to yet another aspect, a vehicle is provided which includes the device for operating a vehicle.

According to yet another aspect, a computer program is provided, which includes program code for carrying out the method for the assisted driving of a vehicle and/or for operating a vehicle if the computer program is executed on a computer.

The present invention thus in particular includes the idea of ascertaining a setpoint trajectory for the vehicle as a function of the type of the vehicle. This means that an optimal setpoint trajectory which is tailored to the vehicle and which the vehicle is to follow in the parking facility is ascertained specifically for the vehicle. It is thus not provided according to the present invention to ascertain a general shared setpoint trajectory for several different vehicles. Rather, a dedicated setpoint trajectory is ascertained for each individual vehicle as a function of its vehicle type. In this way, a setpoint trajectory may advantageously be optimized for the vehicle. In particular, in this way characteristics of the vehicle specifically driving in the parking facility may advantageously be taken into consideration. In this way, a particularly efficient autonomous driving operation of the vehicle in the parking facility is advantageously made possible.

By providing the vehicle with a digital map of the parking facility, an efficient and simplified autonomous driving operation of the vehicle in the parking facility is made possible. This, in particular, being due to the vehicle now being able to adapt its driving operation to a topography of the parking facility. In particular, the digital map may thus advantageously supplement sensor data of a surroundings sensor system with the aid of which the vehicle detects its surroundings. In this way, for example, double checking may take place as to whether, in a location in which a surroundings sensor system has detected an infrastructure of the parking facility, such an infrastructure is in fact present. This takes place in particular with the aid of a comparison to the digital map.

The vehicle being monitored with the aid of a vehicle-external monitoring system while it is autonomously driving in the parking facility in particular yields the technical advantage that errors or problems which may occur while the vehicle is driving autonomously may be identified. In this way, suitable measures may advantageously be taken, for example, to eliminate or remedy these errors or problems.

The combination of the above-mentioned features and their advantages achieves a synergistic effect inasmuch as they advantageously efficiently complement one another and, in sum, enable an improved and efficient autonomous driving operation of the vehicle in the parking facility. As a result of the sum of these measures, a collision risk of the vehicle with other objects in its surroundings may advantageously be considerably reduced or even entirely avoided.

According to one specific embodiment, the communication network includes a WLAN network and/or a mobile communication network.

In one specific embodiment, a communication via the communication network is encrypted.

A parking facility within the meaning of the present invention may also refer to a parking area and serves as a parking area for vehicles. The parking facility thus forms in particular a contiguous area which includes multiple parking spaces (in the case of a parking facility on private property) or parking positions (in the case of a parking facility on public property). According to one specific embodiment, the parking facility may include a parking deck. The parking facility in particular includes a parking garage.

Autonomously within the meaning of the present invention means in particular that the vehicle navigates or drives or is guided independently in the parking facility, i.e., without an intervention of a driver. The vehicle thus drives independently in the parking facility, without a driver having to steer the vehicle or having to be present in the vehicle to do so. A guiding includes in particular transverse and/or longitudinal guidance of the vehicle. Such an autonomously driving vehicle, which is able to automatically park and unpark, is also referred to as an AVP vehicle, for example. AVP stands for “automatic valet parking” and may be referred to as an “automatic parking process.” Vehicles which do not have this AVP functionality are referred to as normal vehicles, for example.

A drop-off position within the meaning of the present invention is a position at which a driver of the vehicle may drop off his/her vehicle for an autonomous parking process and he/she may pick up his/her vehicle again at a later point in time.

A parking position within the meaning of the present invention is a position in which the vehicle is to park autonomously.

A pick-up position within the meaning of the present invention is a position at which a vehicle may be picked up after an autonomous parking process has ended.

According to one specific embodiment, the drop-off position is the same as the pick-up position.

In one specific embodiment, it is provided that the vehicle autonomously navigates or drives from the drop-off position to the parking position.

In one further specific embodiment, it is provided that the vehicle autonomously parks into the parking position.

In one other specific embodiment, it is provided that the vehicle autonomously unparks from the parking position.

According to one further specific embodiment, it is provided that the vehicle autonomously navigates or drives from the parking position to the pick-up position.

According to one other specific embodiment, it is provided that the setpoint trajectory is furthermore ascertained as a function of at least one of the following vehicle parameters: wheelbase, height, width, length, weight, functional scope of a driver assistance system, functional scope of a surroundings sensor system, maximum steering angle, turning circle, imprecision of a driver assistance system and imprecision of a surroundings sensor system.

This in particular yields the technical advantage that the setpoint trajectory may be even better adapted to the vehicle. In this way, an improved efficient autonomous navigation of the vehicle in the parking facility may advantageously be enabled.

The functional scope of a surroundings sensor system includes a range of a surroundings sensor, for example. This includes, for example, a range of a video sensor, a radar sensor, an ultrasonic sensor, a laser sensor or a LIDAR sensor. For example, an accuracy of a camera including a video sensor in general decreases as the distance increases.

The functional scope of a surroundings sensor system includes a sensor sensitivity of a surroundings sensor, for example.

Since a driver assistance system in general uses surroundings sensor data of a surroundings sensor system for carrying out a driver assistance function, a functional scope of the driver assistance system is also defined via the functional scope of the surroundings sensor system.

The functional scope of a driver assistance system includes, for example, a reaction speed to an event, such as the occurrence of an obstacle.

According to one further specific embodiment, multiple vehicle parameters are provided.

According to one specific embodiment, the vehicle type includes the year of manufacture of the vehicle.

According to one further specific embodiment, the vehicle type includes an identifier of a manufacturer of the vehicle.

According to one further specific embodiment, it is provided that, when a problem which occurs during the driving operation is detected, at least one of the following actions (preferably both, in particular first the transmission of the stop signal, and only then the ascertainment of the new setpoint trajectory) are carried out:
ascertaining a new setpoint trajectory and transmitting the new setpoint trajectory to the vehicle via the communication network; and
transmitting a stop signal to the vehicle.

This in particular yields the technical advantage that an occurring problem may be efficiently solved. For example, the new setpoint trajectory may be ascertained acknowledging and taking the detected problem into consideration, i.e., based on the detected problem. This means that the new setpoint trajectory takes the problem into consideration and may accordingly contribute to its remedy or circumvention. Transmitting the stop signal in particular yields the advantage that a collision risk may be considerably reduced. This is because, in general, a stopped vehicle poses a considerably lower collision risk or collision hazard than a driving vehicle. The vehicle thus preferably stops in response to the stop signal.

According to one specific embodiment, it is provided that the problem is detected with the aid of the monitoring system.

According to one further specific embodiment, it is provided that the problem is detected with the aid of the vehicle, in particular with the aid of a surroundings sensor system of the vehicle. The detected problem is then preferably reported by the vehicle via the communication network to a user of the communication network. Such a user is a parking facility management server, for example, which in particular includes the device for the assisted driving of a vehicle. In this way, the parking facility management server, which manages and monitors an operation of the parking facility, may advantageously ascertain and/or plan and/or carry out and/or coordinate effective countermeasures in order to remedy or circumvent the problem which has occurred.

In one other specific embodiment, it is provided that the monitoring includes that the actual trajectory of the vehicle is monitored for a deviation from the ascertained setpoint trajectory. This in particular yields the technical advantage that it is possible to identify whether or not the vehicle deviates from the ascertained setpoint trajectory. Depending on a result of the monitoring, i.e., depending on whether the actual trajectory deviates from the ascertained setpoint trajectory, corresponding countermeasures may be taken. For example, a compensation route may be ascertained, which is able to compensate for the deviation.

According to one specific embodiment, the ascertained compensation route is transmitted to the vehicle via the communication network so that the vehicle is able to compensate for the deviation by following the compensation route. This means that the vehicle, according to one specific embodiment, receives a compensation route and, in response thereto, adapts its autonomous driving operation in such a way that the deviation is compensated. This takes place in particular in that the vehicle autonomously follows the received compensation route.

According to one further specific embodiment, it is provided that, in the event of a deviation, a stop signal is transmitted to the vehicle via the communication network, so that the vehicle is able to stop in response to a receipt of the stop signal. This in particular yields the technical advantage that a collision risk for the vehicle may be considerably reduced or even avoided. This is because a stopped vehicle represents a considerably lower collision hazard than a driving vehicle. In particular, the time during which the vehicle stops may be utilized to ascertain a compensation route, and to transmit the same to the vehicle. Upon receipt of the compensation route, it is provided according to one specific embodiment that the vehicle continues to drive autonomously. This, in particular, by autonomously following the compensation route.

In one other specific embodiment, it is provided that a parking route for parking into and/or an unparking route for unparking from a parking position are ascertained as a function of the vehicle type and transmitted to the vehicle via the communication network, so that the vehicle may autonomously park into or unpark from the parking position.

This in particular yields the technical advantage that the vehicle itself does not necessarily have to include a parking assistance system. This means that the vehicle itself does not have to include an autonomous parking functionality. This is because the route which is required for the vehicle to park or unpark by following this route may be ascertained vehicle-externally. The vehicle itself thus does not have to have knowledge of exact dimensions of the parking position. In particular, the vehicle does not have to have knowledge of potential obstacles in the surroundings of the parking position. The knowledge is thus available vehicle-externally and is provided to the vehicle via the communication network in the form of the parking or unparking route.

According to yet another specific embodiment, it is provided that the parking route or the unparking route is furthermore ascertained as a function of at least one of the following vehicle parameters: wheelbase, height, width, length, weight, functional scope of a driver assistance system, functional scope of a surroundings sensor system, maximum steering angle, turning circle, imprecision of a driver assistance system and imprecision of a surroundings sensor system.

According to one specific embodiment, a surroundings sensor system is provided, in particular the vehicle includes a surroundings sensor system, and the device for operating a vehicle preferably includes a surroundings sensor system. A surroundings sensor system includes in particular one or multiple of the following surroundings sensors: radar sensor, LIDAR sensor, ultrasonic sensor, laser sensor and video sensor.

According to one further specific embodiment, it is provided that, when an obstacle for the vehicle is detected during the monitoring, a circumnavigation route for circumnavigating the obstacle is ascertained, which is transmitted to the vehicle via the communication network, so that the vehicle is able to autonomously circumnavigate the obstacle based on the circumnavigation route. This in particular yields the technical advantage that obstacles which may block a route to be followed may be circumnavigated. This may in particular reduce a collision risk. In particular, an efficient traffic flow may thus be achieved.

According to yet another specific embodiment, it is provided that the setpoint trajectory includes at least one of the following locations in the parking facility: drop-off position at which a driver of the vehicle is able to drop off the vehicle for an autonomous parking process, parking position in which the vehicle parks in the parking facility, and pick-up position at which a driver is able to pick up the vehicle after an autonomous parking process has ended.

This means that, depending on which of the above-mentioned locations the setpoint trajectory includes, the vehicle is able to autonomously drive from the drop-off position to the parking position by autonomously following the setpoint trajectory. In particular, the vehicle may autonomously park there, i.e., in the parking position. In particular, the vehicle may unpark from the parking position.

In particular, the vehicle may autonomously drive from the parking position to the pick-up position, which corresponds to the drop-off position, for example.

This means that, by following the setpoint trajectory, an automatic parking process, a so-called automatic valet parking (AVP), may be achieved.

The vehicle is assisted in its autonomous driving operation inasmuch as the setpoint trajectory to be followed is transmitted to the vehicle via the communication network. The vehicle drives independently, i.e., autonomously, in the parking facility based on the transmitted setpoint trajectory. In particular, no remote control of the vehicle takes place here.

In one other specific embodiment, it is provided that pieces of information regarding mobile and/or stationary objects present within the parking facility are transmitted to the vehicle via the communication network, so that the vehicle is able to take these pieces of information into consideration for its autonomous driving operation in the parking facility. This in particular yields the technical advantage that an efficient autonomous navigation or autonomous driving operation of the vehicle in the parking facility may be achieved. In particular, it is thus possible for the vehicle to take objects situated within the parking facility into consideration for its autonomous driving operation. The vehicle is thus able to accordingly adapt its setpoint trajectory to be followed.

Pieces of information include in particular position data of the mobile and/or stationary objects. This means that the pieces of information include pieces of information as to where the mobile and/or stationary objects are situated within the parking facility, i.e., the positions of the objects.

Pieces of information include, for example, prediction data assigned to the mobile objects. Prediction data correspond to a future, i.e., predicted, movement of these mobile objects. Based thereon, the vehicle is then able to know where the mobile objects are moving to.

A mobile object within the meaning of the present invention may also be referred to as a dynamic object. A stationary object within the meaning of the present invention may also be referred to as a static object. Static objects are, for example, part of an infrastructure of the parking facility. Such an infrastructure includes a barrier, a building, a pillar or curbs, for example. Mobile or dynamic objects are, for example, persons, animals or further vehicles moving on or within the parking facility. For example, a stopped or a parked vehicle is defined as a mobile object, even though it is no longer moving. This is because it has a speed that is 0 m/s during parking. Although an infrastructure of the parking facility also has a speed of 0 m/s, this infrastructure is not defined as a mobile object, but as a static object. This is because a vehicle may have a speed greater than 0 m/s, i.e., it moves. The infrastructure of the parking facility is not able to do so. It is thus provided, for example, that the static objects exclusively include the infrastructure of the parking facility.

This means that a mobile object refers to an object which is able to move or change locations, i.e., it is mobile. An object thus does not necessarily have to be moving to be defined or classified as a mobile object. In contrast, a static object denotes an object which is not able to move, i.e., it is not mobile.

According to one specific embodiment, it is provided that position data assigned to the mobile and/or stationary object(s) are received by the vehicle via the communication network, so that the vehicle autonomously navigates or drives in the parking facility based on the future movements of the mobile object or objects. Thus, the position data are preferably transmitted to the vehicle via the communication network.

This in particular yields the technical advantage that an improved and more efficient navigation of the vehicle in the parking facility is made possible. This is because it is now possible to take positions of the mobile and/or stationary objects into consideration for the navigation or for the driving operation, i.e., in particular for the route planning or trajectory ascertainment. This may advantageously reduce or even entirely avoid a collision risk with the objects.

According to one specific embodiment, it is provided that prediction data, assigned to the mobile object or objects, of future movements of the mobile object or objects are received by the vehicle via the communication network, so that the vehicle autonomously navigates in the parking facility based on the future movements of the mobile object or objects.

This in particular yields the technical advantage that an improved and more efficient navigation of the vehicle in the parking facility is made possible. This is because it is now possible to also take future movements of the mobile objects into consideration for the navigation, i.e., in particular for the route planning. This may advantageously reduce or even entirely avoid a collision risk with the mobile objects.

In one further specific embodiment, it is provided that the setpoint trajectory is designed as a setpoint trajectory tube, so that the vehicle is able to drive within the setpoint trajectory tube while it is autonomously driving in the parking facility. This means that, instead of the wording “setpoint trajectory,” it is also possible to use the wording “setpoint trajectory tube” when the setpoint trajectory is designed as such a setpoint trajectory tube. This means that, according to one specific embodiment, a setpoint trajectory tube is provided.

Such a setpoint trajectory tube is thus a corridor within which a vehicle should or may autonomously drive or navigate. This means that a setpoint trajectory tube includes a plurality of setpoint trajectories. Each trajectory situated within the setpoint trajectory tube is thus a possible setpoint trajectory which the vehicle should or may follow. In light of the present invention, the term “setpoint trajectory” includes not only one setpoint trajectory, but also multiple setpoint trajectories situated within the setpoint trajectory tube.

According to one specific embodiment, it is provided that the device for the assisted driving of a vehicle is designed to implement or carry out the method for the assisted driving of a vehicle.

In one other specific embodiment, it is provided that the device for operating a vehicle is designed or configured to implement or carry out the method for operating a vehicle.

According to yet another specific embodiment, it is provided that the vehicle is configured or designed to implement or carry out the method for operating a vehicle.

According to one specific embodiment, it is provided that the parking position is ascertained as a function of the vehicle type. This may in particular yield the technical advantage that the vehicle fits in a parking position optimized for it in the parking facility. This is because not every vehicle type usually fits equally well in every parking position. For example, a column close to a parking position may make the parking or unparking of a sport utility vehicle considerably more difficult, while a compact car generally has no problems with it.

In one specific embodiment, it is provided that the parking position is ascertained as a function of at least one of the following vehicle parameters: wheelbase, height, width, length, weight, functional scope of a driver assistance system, functional scope of a surroundings sensor system, maximum steering angle, turning circle, imprecision of a driver assistance system and imprecision of a surroundings sensor system. In this way, it is possible to select the parking position even more suitably for the vehicle.

In one specific embodiment, the ascertainment of the parking position includes a selection of a parking position from a plurality of parking positions of the parking facility.

According to one specific embodiment, the device for the assisted driving of a vehicle includes the monitoring system.

According to one specific embodiment, it is provided that the vehicle ascertains an optimized setpoint trajectory based on the digital map and the setpoint trajectory, and autonomously drives in the parking facility based on the optimized setpoint trajectory. This means that it is provided according to this specific embodiment, for example, that the device for the assisted driving of a vehicle ascertains the setpoint trajectory as a specific suggestion for a possible setpoint trajectory and transmits this suggestion to the vehicle. The vehicle, i.e., in particular the device for operating a vehicle, preferably uses this specific suggestion to ascertain, based thereon, a dedicated setpoint trajectory, which is referred to as the optimized setpoint trajectory (this, for example, with the aid of the guide device). This means that the suggested setpoint trajectory may serve as a reference, for example, in order to locate and/or minimize vehicle-internal errors, if necessary.

In one specific embodiment, the device for the assisted driving of a vehicle is included in a parking facility management system.

In one specific embodiment, it is provided that, when the vehicle detects a problem which occurs during the driving operation, the vehicle reports the problem via the communication network to a user of the communication network.

According to one specific embodiment, it is provided that, when the vehicle receives a circumnavigation route for circumnavigating an obstacle via the communication network, the vehicle adapts its autonomous driving operation to the obstacle in such a way that the vehicle autonomously drives around the obstacle based on the circumnavigation route.

According to one specific embodiment, it is provided that, when the vehicle receives pieces of information regarding mobile and/or stationary objects situated within the parking facility via the communication network, the vehicle takes these pieces of information into consideration for its autonomous driving operation in the parking facility, and accordingly adapts its autonomous driving operation, if necessary.

In one other specific embodiment, it is provided that the device for the assisted driving of a vehicle, i.e., in particular the parking facility management system, transmits the position and/or dimensions of other vehicles and/or persons, doing so in particular constantly or continuously.

The piece of information regarding the objects thus includes, for example, dimensions or sizes of the other vehicles and/or persons, i.e., in general of the objects.

According to one specific embodiment, the monitoring system includes one or multiple video cameras and/or one or multiple radar sensors and/or one or multiple ultrasonic sensors and/or one or multiple LIDAR sensors and/or one or multiple laser sensors and/or one or multiple photoelectric barriers and/or one or multiple door opening sensors.

In one specific embodiment, the device for the assisted driving of a vehicle includes the monitoring system.

Functionalities of the method are derived analogously from corresponding functionalities of the devices, and vice versa. This means that method features are derived analogously from corresponding device features, and vice versa. This means, in particular, that, when one feature is described in conjunction with the method or the device for the assisted driving of a vehicle, this feature may similarly be provided in specific embodiments of the method and of the device for operating a vehicle, and vice versa.

The present invention is described in greater detail below based on preferred exemplary embodiments.

### BRIEF DESCRIPTION OF THE DRAWINGS

FIG. 1 shows a flow chart of a method for the assisted driving of a vehicle.

FIG. 2 shows a device for the assisted driving of a vehicle.

FIG. 3 shows a flow chart of a method for operating a vehicle.

FIG. 4 shows a device for operating a vehicle.

FIG. 5 shows a parking system for vehicles.

FIG. 6 shows a vehicle.

### DETAILED DESCRIPTION OF EXAMPLE EMBODIMENTS

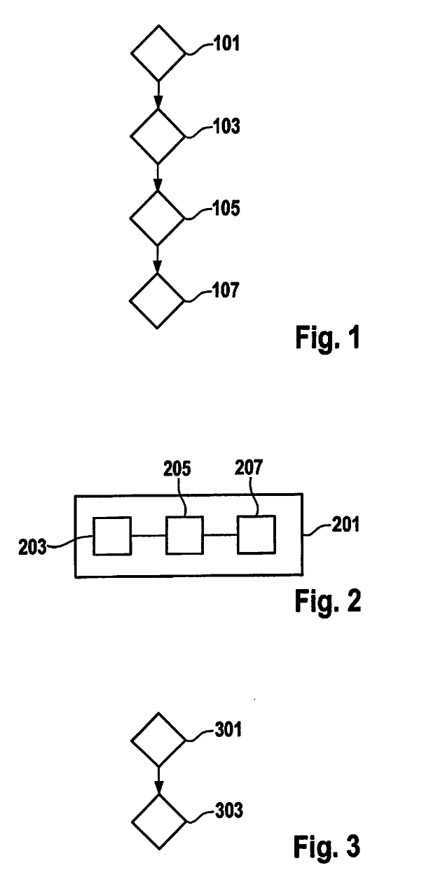

FIG. 1 shows a flow chart of a method for the assisted driving of a vehicle.

In a step 101, it is provided that a setpoint trajectory for the vehicle to be followed in a parking facility is ascertained as a function of a type of the vehicle. The ascertained setpoint trajectory is transmitted in a step 103 to the vehicle via a communication network. Furthermore, according to a step 105, a digital map of the parking facility is transmitted to the vehicle via the communication network. In this way, the vehicle is advantageously able to autonomously drive in the parking facility based on the setpoint trajectory and the digital map.

In a step 107, it is provided that the vehicle is monitored with the aid of a vehicle-external monitoring system while it is driving autonomously in the parking facility.

The fact that the vehicle is monitored while it is driving autonomously in the parking facility means in particular that a parking and/or unparking process of the vehicle into or from a parking position is monitored. In particular, a driving operation from the drop-off position to the parking position is monitored. Preferably, a driving operation from the parking position to the pick-up position is monitored, which according to one specific embodiment is identical to the drop-off position.

FIG. 2 shows a device 201 for the assisted driving of a vehicle.

Device 201 includes a processor 203 which is designed to ascertain a setpoint trajectory for the vehicle to be followed in a parking facility as a function of a type of the vehicle. Device 201 furthermore includes a communication interface 205, which is designed to transmit the ascertained setpoint trajectory and a digital map of the parking facility to the vehicle via a communication network. In this way, the vehicle is advantageously able to autonomously drive in the parking facility based on the setpoint trajectory and the digital map.

Device 201 furthermore includes a control unit 207 for controlling a vehicle-external monitoring system in such a way that the vehicle is monitored with the aid of the vehicle-external monitoring system while it is driving autonomously in the parking facility.

FIG. 3 shows a method for operating a vehicle.

In a step 301, it is provided that the vehicle receives a setpoint trajectory, which is to be followed in the parking facility and is dependent on a type of the vehicle, and a digital map of the parking facility via a communication network. This is according to a step 301. According to a step 303, it is provided that the vehicle autonomously drives in the parking facility based on the setpoint trajectory and the digital map.

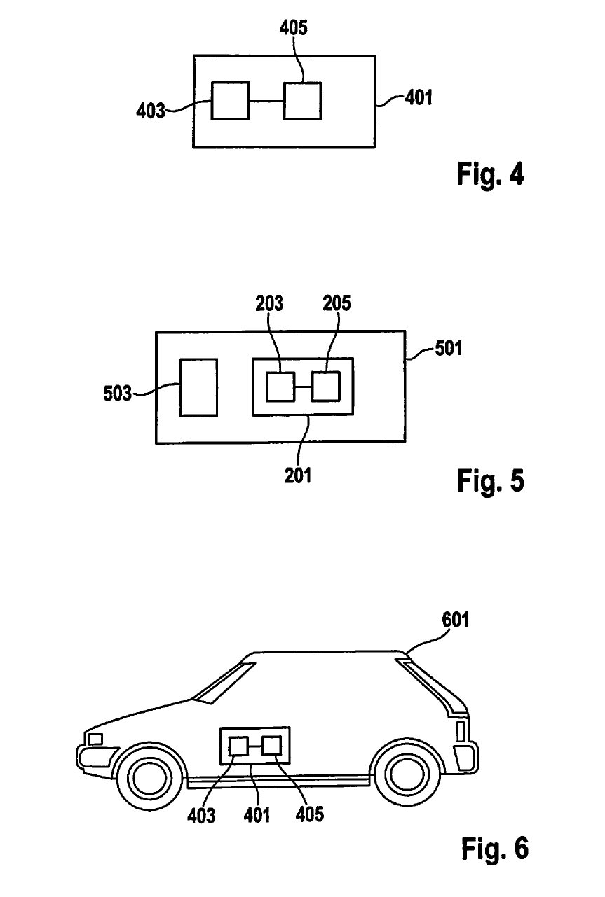

FIG. 4 shows a device 401 for operating a vehicle.

Device 401 includes a communication interface 403 which is designed to receive a setpoint trajectory, which is to be followed in the parking facility and is dependent on a type of the vehicle, and a digital map of the parking facility via a communication network. Device 401 furthermore includes a guide device 405 for guiding the vehicle, which is designed to autonomously guide the vehicle in the parking facility based on the setpoint trajectory and the digital map.

FIG. 5 shows a parking system 501 for vehicles, parking system 501 including a parking facility 503 and device 201 from FIG. 2.

FIG. 6 shows a vehicle 601, which includes device 401 from FIG. 4.

In summary, the present invention in particular and among other things provides an efficient and technical way with the aid of which an autonomous valet parking with vehicles may be carried out efficiently and in an improved manner. According to the present invention, the vehicle drives autonomously based on a digital map, in particular a highly precise digital map, of the parking facility. Such a digital map is thus provided to the vehicle via the communication network. One further idea according to the present invention is in particular the monitoring of the autonomous driving of the vehicle, in particular of the parking/unparking process, with the aid of the vehicle-external monitoring system. In this way, in particular a parking facility management is able to monitor the autonomous driving operation and the parking/unparking process of the vehicle and intervene if needed, i.e., in the event of errors or problems. One further idea according to the present invention is in particular also that a setpoint trajectory to be followed which is specifically tailored to the vehicle is ascertained.

According to one specific embodiment, it is provided that the device for the assisted driving of a vehicle, which may in particular be included in a parking facility management system, specifically calculates or ascertains the set point trajectory or also a setpoint trajectory tube for the vehicle (for example, “Audi A8, 2011 model”).

According to one further specific embodiment, it is provided that the device for the assisted driving of a vehicle, i.e., in particular the parking facility management system, transmits the trajectory or the trajectory tube to the vehicle as a guided route. Guided route here means, in particular, that the vehicle uses the transmitted setpoint trajectory or the transmitted setpoint trajectory tube as a basis for calculating or ascertaining an optimized setpoint trajectory or an optimized setpoint trajectory tube, based on which the vehicle ultimately then autonomously drives in the parking facility.

In one specific embodiment, it is provided that the device for the assisted driving of a vehicle, in particular the parking facility management system, transmits the digital map, in particular the highly precise map, of the parking facility and preferably, if necessary, necessary additional data, for example pieces of information about mobile and/or stationary objects situated within the parking facility, to the vehicle.

In one other specific embodiment, it is provided that the device for the assisted driving of a vehicle, i.e., in particular the parking facility management system, transmits the position and/or dimensions of other vehicles and/or persons, doing so in particular constantly or continuously.

The piece of information thus includes, for example, dimensions or sizes of the other vehicles and/or persons.

In one further specific embodiment, it is provided that the vehicle, based on the transmitted setpoint trajectory or the transmitted setpoint trajectory tube, the digital map, in particular the highly precise map, the positions of other vehicles and/or persons, independently, i.e., autonomously, calculates or ascertains the instantaneously optimal path, and then also autonomously follows the same, and in particular parks and/or unparks.

In one further specific embodiment, it is provided that the device for the assisted driving of a vehicle, i.e., in particular the parking facility management system, monitors the actions, i.e., in particular the autonomous driving operation, of the vehicle. This takes place in particular with the aid of a vehicle-external monitoring system.

In one further specific embodiment, it is provided that the device for the assisted driving of a vehicle, in particular the parking facility management system, intervenes in the case of problems it detects on its own and/or are reported by the vehicle (for example, two vehicles impeding one another; persons running into the driving path of the vehicle; inaccuracies in following the path (i.e., a deviation of the actual from the setpoint trajectory); vehicle losing its localization and the like). This takes place in particular in that, for example, a stop signal is transmitted to the vehicle. This takes place in particular in that, for example, a new setpoint trajectory is ascertained or a new setpoint trajectory tube is ascertained and transmitted to the vehicle via the communication network.

Advantages of example embodiments of the present invention may be achieved or yielded by the combination of the individual features:

A significantly higher robustness.

A significantly higher accuracy.

A significantly lower proneness to errors.

Fewer accidents and/or fewer collisions.

This is achieved in particular compared to conventional parking systems.

1-21. (canceled)

22. A method for the assisted driving of a vehicle, the method comprising:
ascertaining, as a function of a type of the vehicle, a setpoint trajectory for the vehicle to be followed in a parking facility;
transmitting the ascertained setpoint trajectory to the vehicle via a communication network and transmitting a digital map of the parking facility to the vehicle via the communication network so that the vehicle is able to autonomously drive in the parking facility based on the setpoint trajectory and the digital map; and
monitoring the vehicle with the aid of a vehicle-external monitoring system while the vehicle is driving autonomously in the parking facility.

23. The method as recited in claim 22, wherein the setpoint trajectory is ascertained as a function of at least one of the following vehicle parameters: wheelbase, height, width, length, weight, functional scope of a driver assistance system, functional scope of a surroundings sensor system, maximum steering angle, turning circle, imprecision of a driver assistance system, and imprecision of a surroundings sensor system.

24. The method as recited in claim 22, wherein, when a problem which occurs during the driving operation is detected, at least one of the following actions is carried out: (i) ascertaining a new setpoint trajectory and transmitting the new setpoint trajectory to the vehicle via the communication network, and (ii) transmitting a stop signal to the vehicle.

25. The method as recited in claim 22, wherein the monitoring includes monitoring the actual trajectory of the vehicle for a deviation from the ascertained setpoint trajectory.

26. The method as recited in claim 25, wherein, in the event of a deviation, a stop signal is transmitted to the vehicle via the communication network, so that the vehicle is able to stop in response to a receipt of the stop signal.

27. The method as recited in claim 22, wherein at least one of: a parking route for parking into and an unparking route for unparking from a parking position, is ascertained as a function of the vehicle type and transmitted to the vehicle via the communication network, so that the vehicle may autonomously park into or unpark from the parking position.

28. The method as recited in claim 27, wherein the at least one of the parking route and the the unparking route is ascertained as a function of at least one of the following vehicle parameters: wheelbase, height, width, length, weight, functional scope of a driver assistance system, functional scope of a surroundings sensor system, maximum steering angle, turning circle, imprecision of a driver assistance system, and imprecision of a surroundings sensor system.

29. The method as recited in claim 22, wherein, when an obstacle for the vehicle is detected during the monitoring, a circumnavigation route for circumnavigating the obstacle is ascertained, which is transmitted to the vehicle via the communication network, so that the vehicle may autonomously circumnavigate the obstacle based on the circumnavigation route.

30. The method as recited in claim 22, wherein the setpoint trajectory includes at least one of the following locations in the parking facility: drop-off position at which a driver of the vehicle may drop off the vehicle for an autonomous parking process, parking position in which the vehicle parks in the parking facility, and pick-up position at which a driver may pick up the vehicle after an autonomous parking process has ended.

31. The method as recited in claim 22, wherein pieces of information regarding at least one of mobile objects and stationary objects present within the parking facility are transmitted to the vehicle via the communication network, so that the vehicle may take these pieces of information into consideration for its autonomous driving operation in the parking facility.

32. The method as recited in claim 22, wherein the setpoint trajectory is designed as a setpoint trajectory tube, so that the vehicle may drive within the setpoint trajectory tube while it is autonomously driving in the parking facility.

33. A device for the assisted driving of a vehicle, comprising:
a processor designed to ascertain a setpoint trajectory for the vehicle to be followed in a parking facility as a function of a type of the vehicle;
a communication interface designed to transmit the ascertained setpoint trajectory and a digital map of the parking facility to the vehicle via a communication network, so that the vehicle may autonomously drive in the parking facility based on the setpoint trajectory and the digital map; and
a control unit to control a vehicle-external monitoring system in such a way that the vehicle is monitored with the aid of the vehicle-external monitoring system while it is driving autonomously in the parking facility.

34. A method for operating a vehicle, the method comprising:
receiving, by the vehicle via a communication network, (i) a setpoint trajectory, which is to be followed in the parking facility and is dependent on a type of the vehicle, and (ii) a digital map of the parking facility; and
autonomously driving, by the vehicle, in the parking facility based on the setpoint trajectory and the digital map.

35. The method as recited in claim 34, wherein the vehicle ascertains an optimized setpoint trajectory based on the digital map and the setpoint trajectory, and autonomously drives in the parking facility based on the optimized setpoint trajectory.

36. The method as recited in claim 34, wherein, when the vehicle detects a problem which occurs during the driving operation, the vehicle reports the problem via the communication network to a user of the communication network.

37. The method as recited in claim 34, wherein, when the vehicle receives a circumnavigation route for circumnavigating an obstacle via the communication network, the vehicle adapts its autonomous driving operation to the obstacle in such a way that the vehicle autonomously drives around the obstacle based on the circumnavigation route.

38. The method as recited in claim 34, wherein, when the vehicle receives pieces of information regarding at least one of mobile objects and stationary objects situated within the parking facility via the communication network, the vehicle takes these pieces of information into consideration for its autonomous driving operation in the parking facility, and accordingly adapts its autonomous driving operation, if necessary.

39. A device for operating a vehicle, comprising:
a communication interface designed to receive, via a communication network, (i) a setpoint trajectory, which is to be followed in the parking facility and is dependent on a type of the vehicle, and (ii) a digital map of the parking facility; and
a guide device to guide the vehicle, the guide device being designed to autonomously guide the vehicle in the parking facility based on the setpoint trajectory and the digital map.

40. A parking system for vehicles, comprising:
a parking facility; and
a device for the assisted driving of a vehicle, including a processor designed to ascertain a setpoint trajectory for the vehicle to be followed in a parking facility as a function of a type of the vehicle, a communication interface designed to transmit the ascertained setpoint trajectory and a digital map of the parking facility to the vehicle via a communication network, so that the vehicle may autonomously drive in the parking facility based on the setpoint trajectory and the digital map, and a control unit to control a vehicle-external monitoring system in such a way that the vehicle is monitored with the aid of the vehicle-external monitoring system while it is driving autonomously in the parking facility.

41. A vehicle including a device for operating the vehicle, the device including a communication interface designed to receive, via a communication network, (i) a setpoint trajectory, which is to be followed in the parking facility and is dependent on a type of the vehicle, and (ii) a digital map of the parking facility; and a guide device to guide the vehicle, the guide device being designed to autonomously guide the vehicle in the parking facility based on the setpoint trajectory and the digital map.

42. A non-transitory computer readable storage meeting on which is stored a computer program including program code for the assisted driving of a vehicle, the program code, when executed by a computer, causing the computer to perform:
ascertaining, as a function of a type of the vehicle, a setpoint trajectory for the vehicle to be followed in a parking facility;
transmitting the ascertained setpoint trajectory to the vehicle via a communication network and transmitting a digital map of the parking facility to the vehicle via the communication network so that the vehicle is able to autonomously drive in the parking facility based on the setpoint trajectory and the digital map; and
monitoring the vehicle with the aid of a vehicle-external monitoring system while the vehicle is driving autonomously in the parking facility.

43. A non-transitory computer readable storage meeting on which is stored a computer program including program code for operating a vehicle, the program code, when executed by a computer, causing the computer to perform:
receiving, by the vehicle via a communication network, (i) a setpoint trajectory, which is to be followed in the parking facility and is dependent on a type of the vehicle, and (ii) a digital map of the parking facility; and
autonomously driving, by the vehicle, in the parking facility based on the setpoint trajectory and the digital map
